(19) United States
(12) Patent Application Publication
(10) Pub. No.: US 2025/0191861 A1
(43) Pub. Date: Jun. 12, 2025

(54) MEDIUM OR HIGH VOLTAGE VACUUM BREAKER

(71) Applicant: Schneider Electric Industries SAS, Rueil Malmaison (FR)

(72) Inventors: Renaud Carlen, Saint Quentin sur Isere (FR); Mathieu Bono, Saint Pantaleon de Larche (FR)

(73) Assignee: Schneider Electric Industries SAS, Rueil Malmaison (FR)

(21) Appl. No.: 18/971,336

(22) Filed: Dec. 6, 2024

(30) Foreign Application Priority Data
Dec. 8, 2023 (FR) 2313866

(51) Int. Cl. H01H 33/662

(52) U.S. Cl. CPC H01H 33/66207; H01H 33/66261; H01H 2033/66223

(57) ABSTRACT

A medium-or high-voltage vacuum interrupter, including: an insulator forming a receiving enclosure, the insulator being formed of two coaxial elements; two electrical contacts arranged inside the insulator and configured to be moved relative to one another between a closed position and an open position; and a screen radially surrounding the electrical contacts and configured to collect the metal particles emitted when an electric arc passes between the electrical contacts so as to protect the insulator from the metal particles emitted, wherein the screen includes a fixing flange clamped between the two elements of the insulator. The vacuum interrupter further includes a seal made of a semiconductor material surrounding the insulator, the seal being in electrical contact with the screen.

### TECHNICAL FIELD

The present invention relates to the field of medium-or high-voltage vacuum breaking devices, also known as vacuum breakers or vacuum interrupters. Vacuum interrupters are used in electrical devices for distributing medium and high voltages, i.e. voltages from in excess of 1 kV. Vacuum interrupters are associated with actuators with a view to breaking the current in one portion of the circuit.

### PRIOR ART

As is well known, a vacuum interrupter comprises two breaking contacts placed facing each other. Each contact comprises a rod for conducting electrical current and a body integral with the rod.

The contacts are placed in an insulating jacket forming a fluid-tight enclosure placed under vacuum. The contacts may be moved with respect to each other. When the contacts are in abutment with each other, the current may pass from one contact to the other. When the contacts are separated from each other, the current is interrupted.

A protective screen is placed inside the insulating jacket and surrounds the electrical contacts. The screen prevents any metal particles that become detached from the contacts during creation of an electrical arc from settling on the internal surface of the insulating jacket. In order to secure the screen to the insulating jacket, this may be made in two parts placed coaxially next to one another, and a portion of the screen, acting as a retaining flange, is clamped between the two parts of the insulating jacket. This portion of screen that acts as a retaining flange introduces dielectric stresses.

It is desirable to have available vacuum interrupters that are able to withstand higher voltages, without increasing their size and particularly without increasing their diameter. The dielectric stresses generated by the portion of screen acting as a retaining flange are counter-productive as regards this objective.

There is therefore a need for a vacuum interrupter with improved dielectric strength.

### SUMMARY

To this end, the invention proposes a medium-or high-voltage vacuum interrupter, comprising:
an insulator forming a receiving enclosure, the insulator being formed of two coaxial elements,
two electrical contacts arranged inside the insulator and configured to be moved relative to one another between a closed position in which the electrical contacts are in abutment with one another and an open position in which the electrical contacts are separated from one another,
a screen radially surrounding the electrical contacts and configured to collect the metal particles emitted when an electric arc passes between the electrical contacts so as to protect the insulator from the metal particles emitted,
   the screen comprising a fixing flange clamped between the two elements of the insulator,
   characterized in that the vacuum interrupter comprises a seal made of a semiconductor material surrounding the insulator, the seal being in electrical contact with the screen.

The presence of the seal avoids the creation of a triple interface at which the insulator, the screen and the gas surrounding the vacuum interrupter meet. Thanks to the presence of the seal, two triple interfaces are created: a first interface between the insulator, a first portion of the seal and the gas surrounding the vacuum interrupter, and a second interface between the screen, the insulator and a second portion of the seal. This separation of the interfaces makes it possible to increase the dielectric strength of the vacuum interrupter. The semiconductor nature of the material of the seal makes it possible to contrive for the seal to be at the electrical potential of the screen in its entirety, thus allowing the seal to act as an electrical deflector weakening the electrical field in this area. For the same performance, the size of the interrupter can be reduced, or for the same size, the performance of the vacuum interrupter can be improved.

The features listed in the following paragraphs may be implemented independently of one another or in any technically possible combination:

The vacuum interrupter is fluidtight.

The vacuum interrupter is of cylindrical overall shape and extends along an axis.

The insulator, the screen and the electrical contacts are coaxial.

According to one aspect of the invention, the seal made of semiconductor material is made of butadiene-acrylonitrile copolymer.

The seal is elastically deformable.

According to one embodiment of the vacuum interrupter, the seal is in mechanical contact with the fixing flange of the screen.

The seal is in mechanical contact with the insulator.

According to another embodiment of the vacuum interrupter, the seal is distant from the fixing flange of the screen, and an axial surface of at least one of the two coaxial elements of the insulator comprises an electrically conductive coating, the coating being in contact with the seal and with the fixing flange.

The electrically conductive coating present on the axial surface that is in contact, on the one hand, with the fixing flange of the screen and, on the other hand, with the seal makes it possible to ensure electrical contact between the two components. The seal and the screen are thus placed at the same electrical potential.

According to an alternative form of embodiment of the vacuum interrupter, or in addition, a space separating the fixing flange of the screen and the seal contains an electrically conductive grease.

The grease is, for example, a silicone grease.

According to one aspect of the proposed vacuum interrupter, the seal is removable.

According to one example of use, the seal may thus be fitted specifically for the

conditioning procedure aimed at eliminating surface defects of the contact bodies of the vacuum interrupter. The seal may then be removed for using the interrupter in an electrical device.

According to another example of use, the seal may be kept throughout the service life of the vacuum interrupter.

The seal may be added to the vacuum interrupter.

Once fitted, the seal may be removed from the vacuum interrupter.

The insulator has the shape of a cylinder of revolution.

The two elements of the insulator have the shape of a hollow cylinder.

The two elements of the insulator are placed next to one another in an axial direction and are separated from one another by the fixing flange of the screen.

The two elements of the insulator have the same inside diameter.

The two elements of the insulator have the same outside diameter.

The insulator is made of ceramic.

The screen comprises a cylindrical portion surrounding the electrical contacts.

The screen is for example made of copper.

The fixing flange of the screen extends radially towards the outside from an exterior surface of the cylindrical portion of the screen.

The fixing flange of the screen extends in a plane transverse to the axis of the screen.

The fixing flange of the screen is of annular shape.

The fixing flange of the screen is made of copper.

The fixing flange of the screen is in contact with each of the two elements of the insulator.

The fixing flange of the screen is compressed in an axial direction between the two elements of the insulator.

The connection between the fixing flange of the screen and each of the two elements of the insulator is fluidtight.

An axial surface of the first element is in contact with a first face of the fixing flange of the screen.

An axial surface of the second element is in contact with a second face of the fixing flange of the screen.

An exterior lateral surface of the fixing flange is set radially back from an exterior lateral surface of the first element of the insulator. Likewise, the exterior lateral surface of the fixing flange is set radially back from an exterior lateral surface of the second element of the insulator.

An outside diameter of the fixing flange is greater than a mean diameter of the first element and of the second element.

The seal partially covers an exterior lateral surface of the first element and an exterior lateral surface of the second element.

The seal partially covers an axial surface of the first element and an axial surface of the second element.

According to one embodiment of the vacuum interrupter, the seal is toroidal in shape when the seal is in its free state.

According to one embodiment, a diameter of a cross section of the seal is comprised between 5 millimetres and 40 millimetres.

According to one embodiment, a mean diameter of the seal is comprised between 50 millimetres and 200 millimetres.

As a preference, a ratio of the diameter of a cross section of the seal and the mean diameter of the seal is comprised between 0.05 and 0.2.

This form factor allows the seal to conform properly to the shape of the ends of

the elements of the insulator while still also allowing sufficient coverage of the axial end portions of the elements.

According to one embodiment of the vacuum interrupter, the seal in its free state comprises:
a toroidal portion,
an annular portion extending radially inwards, the annular portion being in contact with the first element and with the second element in an axial direction.

The annular part allows the seal to have a shape that promotes the establishing of mechanical contact with the fixing flange of the screen.

A first face of the annular portion is in contact with an axial surface of the first element of the insulator.

A second face of the annular portion, the opposite face to the first face, is in contact with an axial surface of the second element of the insulator.

The annular portion extends towards the axis of the toroidal portion in an equatorial plane of the toroidal part.

According to one embodiment of the vacuum interrupter, the annular portion of the seal is distant from the fixing flange of the screen.

More specifically, the annular portion of the seal is distant from an exterior lateral surface of the fixing flange of the screen.

A lateral surface of the annular portion of the seal is distant, in a radial direction, from the exterior lateral surface of the fixing flange of the screen.

An exterior lateral surface of the fixing flange, a lateral surface of the annular portion of the seal, an axial surface of the first element and an axial surface of the second element together define a volume of annular shape.

A volume separating the annular portion of the seal and the fixing flange of the screen is at least partially filled with an electrically conductive grease.

The volume separating the annular portion of the seal and the fixing flange of the screen may be completely filled with an electrically conductive grease.

The cavity delimited by the exterior lateral surface of the fixing flange, the lateral surface of the annular portion of the seal, an axial surface of the first element and an axial surface of the second element is partially or completely filled with an electrically conductive grease.

A ratio between the diameter of a cross section of the toroidal part and the outside diameter of the insulator is comprised between 0.05 and 0.2.

A ratio between the inside diameter of the toroidal part and the outside diameter of the insulator is comprised between 0.8 and 0.95.

A portion of the first element in contact with the seal has a chamfer.

Likewise, a portion of the second element in contact with the seal has a chamfer.

The invention also relates to a method for conditioning a vacuum interrupter. The method comprises the steps of:
(i) providing a vacuum interrupter comprising:
an insulator forming a receiving enclosure, the insulator being formed of two coaxial elements,
a pair of electrical contacts which is placed in the insulator, the pair comprising a mobile contact and a fixed contact,
a screen radially surrounding the electrical contacts and configured to collect the metal particles emitted when an electric arc passes between the electrical contacts so as to protect the insulator from the metal particles emitted,
the screen comprising a fixing flange clamped between the two elements of the insulator,
(ii) supplying a seal,
(iii) equipping the vacuum interrupter with a seal surrounding the insulator, the seal being in electrical contact with the screen,
(iv) separating the contacts of the vacuum interrupter and increasing an electrical voltage between the electrical contacts until an electrical arc is created between the contacts,
(v) repeating the step of creating an electrical arc so as to condition the surfaces of the electrical contacts,
(vi) removing the seal from the vacuum interrupter.

The addition of the seal for the phase of conditioning the vacuum interrupter allows the voltage between the electrical contacts to be increased without creating any electrical discharge between the insulator of the vacuum interrupter and the external environment.

Electrical arcs created are encouraged to be so between the electrical contacts, thereby making it possible to accelerate the conditioning of the vacuum interrupter.

Step (vi) is optional.

According to an alternative form of the proposed conditioning method, the seal may remain fitted to the vacuum interrupter for the entire service life of the vacuum interrupter.
In that case, the interrupter is mounted in an electrical device while still fitted with its seal.
The presence of the seal makes it possible to improve the dielectric strength of the vacuum interrupter while it is in service.

Step (vi) of removing the seal is thus replaced by a step:
(vi′) of keeping the seal on the vacuum interrupter up to the mounting of the vacuum interrupter in an electrical device.

### BRIEF DESCRIPTION OF THE DRAWINGS

Further features, details and advantages will become apparent from reading the detailed description below and from analysing the appended drawings, in which:

FIG. 1 is a schematic side view of a vacuum interrupter,

FIG. 2 is a side view, in cross section, of a vacuum interrupter,

FIG. 3 is a side view of a vacuum interrupter according to one embodiment of the invention,

FIG. 4 is a partial view, from the side and in cross section, of the vacuum interrupter of FIG. 3, not fitted with its seal,

FIG. 5 is a partial view, from the side and in cross section, of the vacuum interrupter of FIG. 3,

FIG. 6 is a partial view, from the side and in cross section, of an alternative form of embodiment of the vacuum interrupter of FIG. 3,

FIG. 7 depicts a seal for fitting to a vacuum interrupter according to one embodiment,

FIG. 8 depicts a seal for fitting to a vacuum interrupter according to another embodiment,

FIG. 9 is a block diagram of a method for conditioning a vacuum interrupter according to the invention.

### DESCRIPTION OF THE EMBODIMENTS

In order to make the figures easier to read, the various elements are not necessarily depicted to scale. In these figures, identical elements bear the same reference signs. Certain elements or parameters may be indexed, that is to say designated for example as the first element or the second element, or indeed the first parameter and the second parameter, etc. The aim of this indexing is to differentiate between elements or parameters which are similar but not identical. This indexing does not imply the priority of one element or parameter with respect to another, and the denominations may be interchanged. When it is specified that a subsystem comprises a given element, this does not exclude the presence of other elements in that subsystem. Likewise, when it is specified that a subsystem comprises a given element, it is understood that the subsystem comprises at least this element.

In the various figures, the axes X, Y, Z designate the three directions in space so that the viewpoint for each figure can be identified.

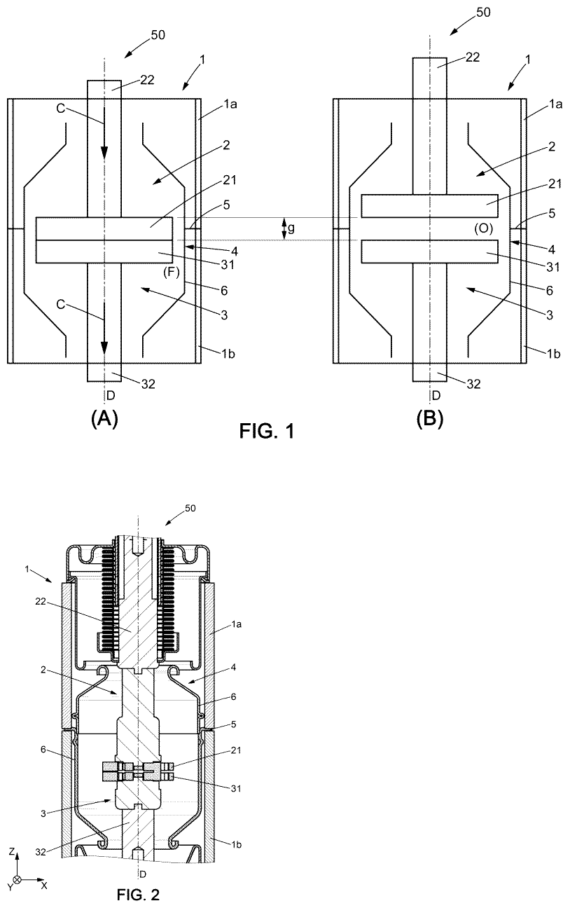

FIG. 1 depicts, as does FIG. 2, a medium-or high-voltage vacuum interrupter 50.

The vacuum interrupter 50 comprises:
a first electrical breaker contact 2,
a second electrical breaker contact 3.
   Of the first contact 2 and the second contact 3 at least one is configured to be moved along an axis D between a position referred to as open O in which the electrical contacts 2, 3 are separated from one another, and a position referred to as closed F in which the electrical contacts 2, 3 are in abutment with one another so as to allow electrical current to pass between the first contact 2 and the second contact 3.

The vacuum interrupter 50 forms part of a medium-voltage breaker device such as a circuit breaker or a disconnector.

In the part A of FIG. 1, the electrical breaker contacts 2, 3 are in contact with one another and an electrical current may flow. In the part A of FIG. 1, the sign C indicates the passage of the electrical current.
When the contacts 2, 3 are separated from one another, the flow of electrical current is interrupted, generally after a transient period during which an electrical arc is present between the two electrical contacts 2, 3.
In the part B of FIG. 1, the electrical contacts are separated by a distance indicated by the sign g, and the flow of electrical current from one contact to the other is interrupted.

The first electrical contact 2 comprises a cylindrical rod 22 and a contact body 21 in the form of a disc. The contact body 21 is integral with the rod 22 and extends transversely with respect to the cylindrical rod 22.

Likewise, the second electrical contact 3 comprises a cylindrical rod 32 and a contact body 31 in the form of a disc, integral with the rod 32 and extending transversely with respect to the cylindrical rod 32.
Each contact body 21, 31 is fixed respectively to the cylindrical rod 22, 32, for example by brazing.
When the electrical contacts 2, 3 are in contact, the contact body 21 and the contact body 31 are in abutment with one another. In the closed position, a spring, not depicted, maintains a preload between the contact bodies 21, 31. In other words, a contact pressure is applied, in the closed position, between the contact bodies 21, 31, this contact pressure being determined by the force applied by the spring.
The preloading spring forms part of the control mechanism that controls the vacuum interrupter 50.
The electrical contacts 2, 3 are arranged inside an insulating jacket also referred to as an insulator 1.
A protective screen 4 is placed inside the insulator 1, being positioned radially between the electrical contacts 2, 3 and the interior wall of the insulator 1. The protective screen 4 prevents any metal particles that become detached from the contacts 2, 3 during creation of electrical arcs from settling on the internal surface of the insulator 1.

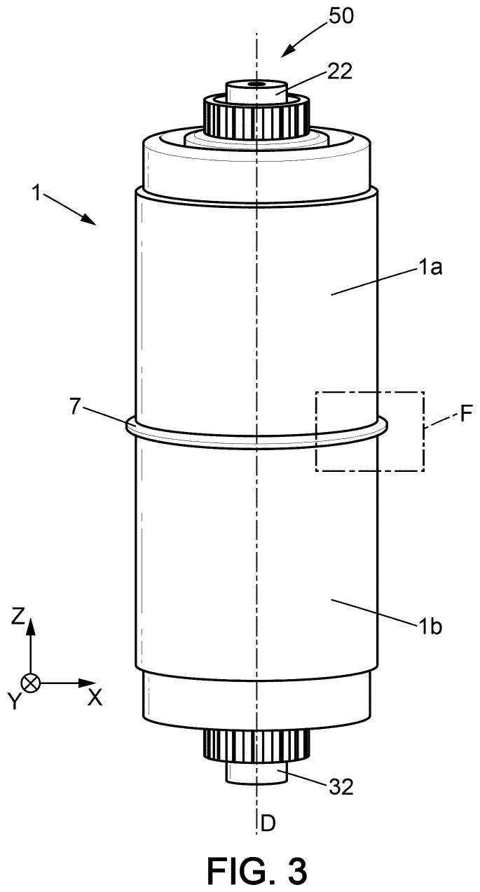

FIG. 3 is an external view of the proposed vacuum interrupter 50.

The medium-or high-voltage vacuum interrupter 50 comprises:
an insulator 1 forming a receiving enclosure, the insulator 1 being formed of two coaxial elements 1a, 1b,
two electrical contacts 2, 3 arranged inside the insulator 1 and configured to be moved relative to one another between a closed position F in which the electrical contacts 2, 3 are in abutment with one another and an open position O in which the electrical contacts 2, 3 are separated from one another,
a screen 4 radially surrounding the electrical contacts 2, 3 and configured to collect metal particles emitted when an electric arc passes between the electrical contacts 2, 3 so as to protect the insulator 1 from the metal particles emitted.

The screen 4 comprises a fixing flange 5 clamped between the two elements 1a, 1b of the insulator 1.

The vacuum interrupter 50 comprises a seal 7 made of a semiconductor material surrounding the insulator 1, the seal 7 being in electrical contact with the screen 4.

The presence of the seal 7 avoids the creation of a triple interface at which the insulator 1, the screen 4 and the gas surrounding the vacuum interrupter 50 meet. Thanks to the presence of the seal 7, two distinct triple interfaces are created: a first triple interface between the insulator 1, a first portion of the seal 7 and the gas surrounding the vacuum interrupter 50, and a second triple interface between the screen 4, the insulator 1 and a second portion of the seal 7.

This separation of the triple interfaces makes it possible to increase the dielectric strength of the vacuum interrupter 50. The semiconductor nature of the material of the seal 7 makes it possible to contrive for the seal 7 to be at the electrical potential of the screen 4 in its entirety, thus allowing the seal 7 to act as an electrical deflector weakening the electrical field in this area. For the same performance, the size of the interrupter can be reduced, or for the same size, the performance of the vacuum interrupter can be improved.

The vacuum interrupter 50 is of cylindrical overall shape and extends along an axis D.

The insulator 1 has the shape of a cylinder of revolution.

The two elements 1a, 1b of the insulator 1 have the shape of a hollow cylinder.

The two elements 1a, 1b of the insulator 1 are placed next to one another in an axial direction and are separated from one another by the fixing flange 5 of the screen 4.
The insulator 1, the screen 4 and the electrical contacts 2, 3 are coaxial. The axis D is the axis common to the first element 1a of the insulator 1, to the second element 1b of the insulator 1, to the screen 4, to the first electrical contact 2 and to the second electrical contact 3.

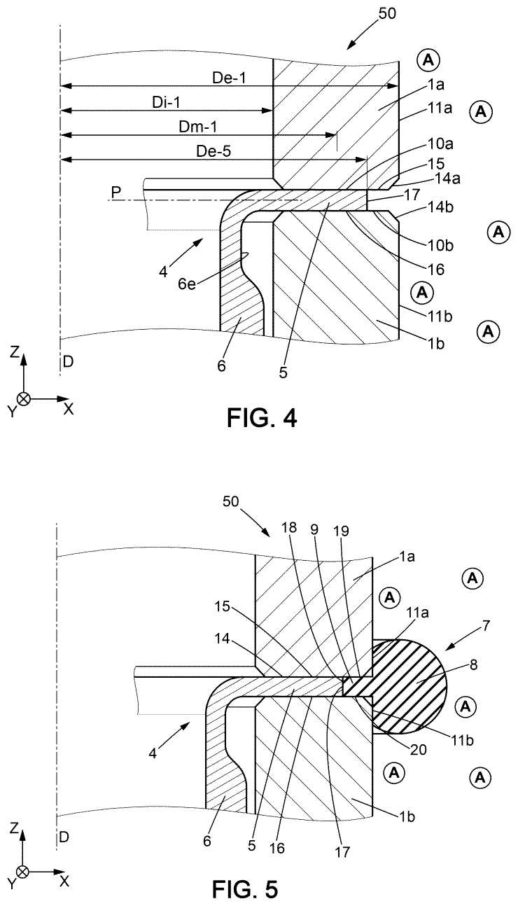

FIG. 4 depicts a vacuum interrupter 50 in which the seal 7 is not fitted.

The two elements 1a, 1b of the insulator 1 have the same inside diameter. This inside diameter is denoted by the sign Di-1 in FIG. 4.
The two elements 1a, 1b of the insulator 1 have the same outside diameter. This outside diameter is denoted by the sign De-1 in FIG. 4.

The insulator 1 is made of ceramic.

The insulator 1 is for example made of alumina (of chemical formula Al₂O₃).
More specifically, each element 1a, 1b is made of ceramic, for example of alumina.

The screen 4 comprises a cylindrical portion 6 surrounding the electrical contacts 2, 3.

The cylindrical portion 6 extends along the rods 22, 32 and faces the contact bodies 21, 31.
The screen 4 is for example made of copper.
The fixing flange 5 of the screen 4 extends radially towards the outside from an exterior surface 6e of the cylindrical portion 6 of the screen 4.

The fixing flange 5 of the screen 4 extends in a plane P transverse to the axis D of the screen 4.

The fixing flange 5 of the screen 4 is of annular shape.
The fixing flange 5 of the screen 4 is made of copper.
The fixing flange 5 of the screen 4 is fixed to the cylindrical portion 6 surrounding the electrical contacts 2, 3 using brazing.
The fixing flange 5 and the cylindrical part 6 of the screen 4 are thus at the same electrical potential.

The fixing flange 5 of the screen 4 is in contact with each of the two elements 1a, 1b of the insulator 1.

The fixing flange 5 of the screen 4 is compressed in an axial direction between the two elements 1a, 1b of the insulator 1.
The connection between the fixing flange 5 of the screen 4 and each of the two elements 1a, 1b of the insulator is fluidtight.

An axial surface 10a of the first element 1a is in contact with a first face 15 of the fixing flange 5 of the screen 4.

An axial surface 10b of the second element 1b is in contact with a second face 16 of the fixing flange 5 of the screen 4.

The vacuum interrupter 50 is fluidtight.

The pressure inside the vacuum interrupter 50 is for example lower than 10-4 millibar.
The gaseous environment in which the vacuum interrupter 50 is placed is for example ambient air. The ambient air in which the vacuum interrupter is placed is indicated schematically by the signs A in FIGS. 4, 5, 6.

An exterior lateral surface 17 of the fixing flange 5 is set radially back from an exterior lateral surface 11a of the first element 1a of the insulator 1.

Likewise, the exterior lateral surface 17 of the fixing flange 5 is set radially back from an exterior lateral surface 11b of the second element 1b of the insulator 1.
An outside diameter De-5 of the fixing flange 5 is greater than a mean diameter Dm-1 of the first element 1a and of the second element 1b.
The mean diameter Dm-1 of the first element 1a is the mean of the inside diameter Di-1 and the outside diameter De-1.

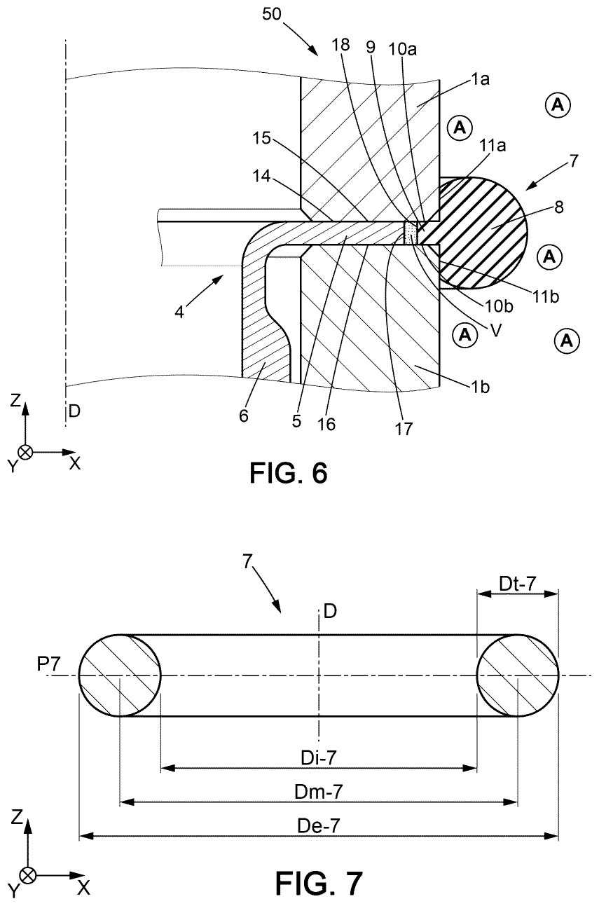

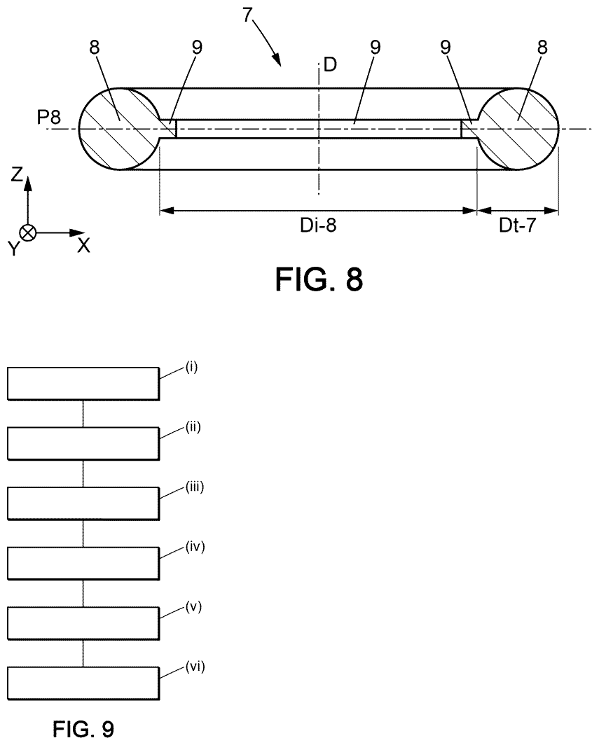

FIG. 5 and FIG. 6 are views of the area denoted by the sign F in FIG. 4. In these figures, the vacuum interrupter 50 is fitted with a seal 7.

The seal 7 made of semiconductor material is made of butadiene-acrylonitrile copolymer.

This material is also referred to as nitrile rubber and is commonly designated by its acronym NBR, which stands for nitrile butadiene rubber.
The seal 7 is elastically deformable.

The seal 7 in the example illustrated is a one-piece component.

The seal 7 is obtained for example by moulding.

According to one embodiment of the vacuum interrupter 50, illustrated in FIG. 5, the seal 7 is in mechanical contact with the fixing flange 5 of the screen 4.

Electrical contact between the seal 7 and the fixing flange 5 of the screen 4 is therefore obtained by establishing direct mechanical contact between the two components.

The seal 7 is in mechanical contact with the insulator 1.

More specifically, the seal 7 is in mechanical contact with the first element 1a of the insulator 1. The seal 7 is also in mechanical contact with the second element 1b of the insulator 1.
The seal 7 surrounds the insulator 1 and partially covers the exterior surface 11a of the first element 1a of the insulator 1, as well as the exterior surface 11b of the second element 1b.

The seal 7 partially covers an exterior lateral surface 11a of the first element 1a and an exterior lateral surface 11b of the second element 1b.

The seal 7 partially covers an axial surface 10a of the first element 1a and an axial surface 10b of the second element 1b.

FIG. 6 illustrates an embodiment of the vacuum interrupter 50 in which the seal 7 is distant from the fixing flange 5 of the screen 4.

A space denoted by the sign V radially separates the fixing flange 5 and the screen 4. The seal 7 is not in mechanical contact with the fixing flange 5 of the screen 4.

An axial surface 10a, 10b of at least one of the two coaxial elements 1a, 1b of the insulator 1 comprises an electrically conductive coating 14, the coating 14 being in contact with the seal 7 and with the fixing flange 5.

The electrically conductive coating 14 is present on an axial surface of at least one element 1a, 1b, this axial surface being in contact on the one hand with the fixing flange 5 of the screen 4, and on the other hand with the seal 7. The coating 14 makes it possible to ensure electrical continuity between the seal 7 and the fixing flange 5. The seal 7 and the screen 4 are thus placed at the same electrical potential.

The coating 14 is, for example, a layer of metal deposited on the axial end of one element of the insulator 1.

According to the example of FIG. 6, only the first element 1a of the insulator 1 has the electrically conductive coating 14.
According to an example which has not been depicted, the first element 1a and the second element 1b each comprise an electrically conductive coating deposited on their respective axial end.

A space V separating the fixing flange 5 of the screen 4 and the seal 7 contains an electrically conductive grease.

Electrical contact between the seal 7 and the fixing flange 5 of the screen 4 may be obtained, or enhanced, by the electrical conduction of the grease interposed between the seal 7 and the fixing flange 5 of the screen 4.

In addition, the grease in the annular space V between the seal 7 and the fixing flange 5 of the screen 4 makes it possible to avoid the presence of air bubbles in this space separating the two components.

The grease is, for example, a silicone grease.

The seal 7 is removable.

According to one example of use, the seal 7 may thus be fitted specifically for the conditioning procedure performed during the manufacture of the vacuum interrupter 50.

This conditioning procedure is aimed at eliminating surface defects of the contact bodies 21, 31 of the vacuum interrupter 50.
In order to do that, electrical arcs are created between the contacts, and these electrical arcs cause any surface defects that form angular singularities on the surface of the new contact bodies to melt and to disappear.
The seal 7 may then be removed once the procedure of conditioning the vacuum interrupter 50 has been completed. The seal 7 is thus absent from the vacuum interrupter 50 when the vacuum interrupter 50 is being used in an electrical device.

According to another example of use, the seal 7 may be kept throughout the service life of the vacuum interrupter 50.

The seal 7 is for example fitted before the conditioning procedure and then left in place.

The seal 7 may be added to the vacuum interrupter 50.

Once fitted, the seal 7 may be removed from the vacuum interrupter 50.

The seal 7 may be fitted and removed multiple times in succession without becoming damaged.

The seal 7 may for example be removed to make it easier to install the vacuum interrupter 50 in an electrical device.

According to one embodiment of the vacuum interrupter 50, the seal 7 is toroidal in shape when the seal 7 is in its free state.

In other words, in the absence of any mechanical stress liable to deform the seal, the seal has the shape of a torus.
FIG. 7 depicts the seal 7 in its free state, which is to say not fitted to the vacuum interrupter 50.

According to one embodiment, a diameter Dt-7 of a cross section of the seal 7 is comprised between 5 millimetres and 40 millimetres.

The diameter Dt-7 of a cross section of the seal 7 is the diameter in its free state, which is to say without deformation. This is therefore the dimension when the seal 7 is not fitted on the vacuum interrupter 50.
The diameter Dt-7 is also referred to as torus diameter.

According to one embodiment, a mean diameter Dm-7 of the seal 7 is comprised between 50 millimetres and 200 millimetres.

What is meant by the mean diameter of the torus is the mean of the inside diameter Di-7 of the torus and the outside diameter De-7 of the torus.
As before, the mean diameter Dm-7 of the seal 7 is the diameter in its free state, which is to say without deformation.
The inside diameter Di-7 and the outside diameter De-7 are measured parallel to the equatorial plane P7 of the seal 7.

As a preference, a ratio of the diameter Dt-7 of a cross section of the seal 7 and the mean diameter Dm-7 of the seal 7 is comprised between 0.05 and 0.2.

This form factor allows the seal 7 to conform properly to the shape of the ends of the lateral surface of the elements 1a, 1b of the insulator 1 while still also allowing sufficient coverage of the axial end portions 10a, 10b of the elements 1a, 1b.

According to the embodiments illustrated in FIGS. 5 and 6, the seal 7 in its free state comprises:
a toroidal portion 8,
an annular portion 9 extending radially inwards, the annular portion 9 being in contact with the first element 1a and with the second element 1b in an axial direction.

The annular part 9 allows the seal 7 to have a shape that promotes the establishing of mechanical contact with the fixing flange 5 of the screen 4.

A first face 19 of the annular portion 9 is in contact with an axial surface 10a of the first element 1a of the insulator 1.

A second face 20 of the annular portion 9, the opposite face to the first face 19, is in contact with an axial surface of the second element 1b of the insulator 1.

The annular portion 9 extends towards the axis D of the toroidal portion 8 in an equatorial plane P8 of the toroidal part 8.

The thickness of the annular part 9 is less than the diameter of the toroidal part 8. The annular part 9 can thus easily be inserted into the space separating the axial surface 10a of the first element 1a from the axial surface 10b of the second element 1b.

In FIG. 5 and in FIG. 6, the toroidal part 8 is depicted with the deformation experienced on contact with the exterior surface 11a, 11b of the insulator 1 schematically taken into consideration.

According to the embodiment of FIG. 6, the annular portion 9 of the seal 7 is distant from the fixing flange 5 of the screen 4.

More specifically, the annular portion 9 of the seal 7 is distant from an exterior lateral surface 17 of the fixing flange 5 of the screen 4.

A lateral surface 18 of the annular portion 9 of the seal 7 is thus distant, in a radial direction, from the exterior lateral surface 17 of the fixing flange 5 of the screen 4.

In other words, there is a radial clearance between the annular portion 9 of the seal 7 and the fixing flange 5 of the screen 4.

An exterior lateral surface 17 of the fixing flange 5, a lateral surface 18 of the annular portion 9 of the seal 7, an axial surface 10a of the first element 1a and an axial surface 10b of the second element 1b together define a volume V of annular shape.

The volume V separating the annular portion 9 of the seal 7 and the fixing flange 5 of the screen 4 is at least partially filled with an electrically conductive grease.

The volume V separating the annular portion 9 of the seal 7 and the fixing flange 5 of the screen 4 may be completely filled with an electrically conductive grease.

The cavity delimited by the exterior lateral surface 17 of the fixing flange 5, the lateral surface 18 of the annular portion 9 of the seal 7, an axial surface 10a of the first element 1a and an axial surface 10b of the second element 1b is partially or completely filled with an electrically conductive grease.

A ratio between the diameter of a cross section of the toroidal part 8 and the outside diameter De-1 of the insulator 1 is comprised between 0.05 and 0.2.

A ratio between the inside diameter of the toroidal part 8 and the outside diameter De-1 of the insulator 1 is comprised between 0.8 and 0.95.

A portion of the first element 1a in contact with the seal 7 has a chamfer 14a.

Likewise, a portion of the second element 1b in contact with the seal 7 has a chamfer 14b.
The chamfer 14a of the first element 1a connects a portion of the axial surface 10a of the first element 1a and a portion of the exterior lateral surface 11a of the first element 1a.
The same goes for the chamfer 14b of the second element 1b.

The chamfers 14a, 14b make it easier to insert the seal 7 between the axial surfaces 10a, 10b of the first element 1a and of the second element 1b.

A conditioning method may be applied to a vacuum interrupter. This conditioning is applied when the interrupter is new, before it is installed in an electrical device.

The invention also relates to a method for conditioning a vacuum interrupter 50.

The method for conditioning a vacuum interrupter 50 comprises the steps of:
(i) providing a vacuum interrupter 50 comprising:
an insulator 1 forming a receiving enclosure, the insulator 1 being formed of two coaxial elements 1a, 1b,
a pair of electrical contacts 2, 3 which is placed in the insulator 1, the pair comprising a mobile contact 2 and a fixed contact 3,
a screen 4 radially surrounding the electrical contacts 2, 3 and configured to collect the metal particles emitted when an electric arc passes between the electrical contacts 2, 3 so as to protect the insulator 1 from the metal particles emitted,
the screen 4 comprising a fixing flange 5 clamped between the two elements 1a, 1b of the insulator 1,
(ii) supplying a seal 7,
(iii) equipping the vacuum interrupter 50 with a seal 7 surrounding the insulator 1, the seal 7 being in electrical contact with the screen 4,
(iv) separating the contacts of the vacuum interrupter 50 and increasing an electrical voltage between the electrical contacts 2, 3 until an electrical arc is created between the contacts 2, 3,
(v) repeating step (iv) of creating an electrical arc so as to condition the surfaces of the electrical contacts 2, 3,
(vi) removing the seal 7 from the vacuum interrupter 50.

The addition of the seal 7 for the phase of conditioning the vacuum interrupter 50 allows the voltage between the electrical contacts 2, 3 to be increased without creating any electrical discharge between the insulator of the vacuum interrupter 50 and the external environment.

Electrical arcs created are encouraged to be so between the electrical contacts 2, 3, thereby making it possible to increase the voltage at which the conditioning is performed. The duration of the phase of conditioning the vacuum interrupter 50 can thus be shortened.

Step (vi) is optional.

According to an alternative form of the proposed conditioning method, the seal 7 may remain fitted to the vacuum interrupter 50 for the entire service life of the vacuum interrupter 50.
The interrupter is then mounted in an electrical device while still fitted with its seal 7.
The presence of the seal 7 makes it possible to improve the dielectric strength of the vacuum interrupter 50 while it is in surface in addition to enabling the conditioning phase to be accelerated.

5 Step (vi) of removing the seal 7 is thus replaced by a step of:
(vi′) keeping the seal 7 on the vacuum interrupter 50 up to the mounting of the vacuum interrupter 50 in an electrical device.
   The electrical device may for example be a circuit breaker.

1. A medium-or high-voltage vacuum interrupter, comprising:
an insulator forming a receiving enclosure, the insulator being formed of two coaxial elements,
two electrical contacts arranged inside the insulator and configured to be moved relative to one another between a closed position in which the electrical contacts are in abutment with one another and an open position in which the electrical contacts are separated from one another,
a screen radially surrounding the electrical contacts configured to collect metal particles emitted when an electric arc passes between the electrical contacts so as to protect the insulator from the metal particles emitted,
the screen comprising a fixing flange compressed in an axial direction between the two elements of the insulator,
wherein the vacuum interrupter comprises a removable seal made of a semiconductor material surrounding the insulator, the seal being in electrical contact with the screen.

2. The vacuum interrupter according to claim 1, wherein the seal made of semiconductor material is made of butadiene-acrylonitrile copolymer.

3. The vacuum interrupter according to claim 1, wherein the seal is in mechanical contact with the fixing flange of the screen.

4. The vacuum interrupter according to claim 1, wherein the seal is distant from the fixing flange of the screen, and wherein an axial surface of at least one of the two coaxial elements of the insulator comprises an electrically conductive coating, the coating being in contact with the seal and with the fixing flange.

5. The vacuum interrupter according to claim 1, wherein a space separating the fixing flange of the screen and the seal contains an electrically conductive grease.

6. The vacuum interrupter according to claim 1, wherein:
the seal partially covers an exterior lateral surface of the first element and an exterior lateral surface of the second element, and
the seal partially covers an axial surface of the first element and an axial surface of the second element.

7. The vacuum interrupter according to claim 1, wherein the seal is toroidal in shape when the seal is in its free state.

8. The vacuum interrupter according to claim 1, wherein a ratio of a diameter of a cross section of the seal and a mean diameter of the seal is comprised between 0.05 and 0.2.

9. The vacuum interrupter according to claim 1, wherein the seal in its free state comprises:
a toroidal portion,
an annular portion extending radially inwards, the annular portion being in contact with the first element and with the second element in an axial direction.

10. The vacuum interrupter according to claim 9, wherein the annular portion extends towards the axis of the toroidal portion in an equatorial plane of the toroidal part.

11. The vacuum interrupter according to claim 9, wherein a ratio between a diameter of a cross section of the toroidal part and an outside diameter of the insulator is comprised between 0.05 and 0.2.

12. The vacuum interrupter according to claim 9, wherein a ratio between an inside diameter of the toroidal part and an outside diameter of the insulator is comprised between 0.8 and 0.95.

13. The vacuum interrupter according to claim 1, wherein:
a portion of the first element in contact with the seal has a chamfer, and
a portion of the second element in contact with the seal has a chamfer.

14. A method for conditioning a vacuum interrupter, comprising:
(i) providing a vacuum interrupter comprising:
an insulator forming a receiving enclosure, the insulator being formed of two coaxial elements,
a pair of electrical contacts which is placed in the insulator, the pair comprising a mobile contact and a fixed contact,
a screen radially surrounding the electrical contacts and configured to collect metal particles emitted when an electric arc passes between the electrical contacts so as to protect the insulator from the metal particles emitted,
the screen comprising a fixing flange compressed in an axial direction between the two elements of the insulator,
(ii) supplying a seal,
(iii) equipping the vacuum interrupter with a seal surrounding the insulator, the seal being in electrical contact with the screen,
(iv) separating the contacts of the vacuum interrupter and increasing an electrical voltage between the electrical contacts until an electrical arc is created between the contacts,
(v) repeating creating an electrical arc so as to condition the surfaces of the electrical contacts.
